(19) United States
(12) Patent Application Publication
(10) Pub. No.: US 2024/0333458 A1
(43) Pub. Date: Oct. 3, 2024

(54) DOWNLINK-ONLY OR UPLINK-ONLY STATE CONFIGURATION

(71) Applicant: QUALCOMM Incorporated, San Diego, CA (US)

(72) Inventors: Ahmed Attia ABOTABL, San Diego, CA (US); Diana MAAMARI, San Diego, CA (US); Marwen ZORGUI, San Diego, CA (US)

(21) Appl. No.: 18/191,482

(22) Filed: Mar. 28, 2023

(51) Int. Cl. H04L 5/00; H04L 5/14

(52) U.S. Cl. CPC H04L 5/0053; H04L 5/14

(57) ABSTRACT

Various aspects of the present disclosure generally relate to wireless communication. In some aspects, a user equipment (UE) may receive a first signal configuration including one or more initial downlink (DL) slots or symbols and one or more initial uplink (UL) slots or symbols. The UE may receive signaling indicating a transition of a network node to a low energy state. The UE may apply a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols. Numerous other aspects are described.

### FIELD OF THE DISCLOSURE

Aspects of the present disclosure generally relate to wireless communication and to techniques and apparatuses for communication during downlink-only or uplink-only states.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include receiving a first signal configuration including one or more initial downlink (DL) slots or symbols and one or more initial uplink (UL) slots or symbols. The method may include receiving signaling indicating a transition of a network node to a low energy state. The method may include applying a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

Some aspects described herein relate to a method of wireless communication performed by a network node. The method may include transmitting a first signal configuration including one or more initial DL slots or symbols and one or more initial UL slots or symbols. The method may include transmitting signaling indicating a transition of a network node to a low energy state. The method may include configuring a UE to apply a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture.

FIGS. 4A, 4B, 4C, and 4D depict aspects of data structures for a wireless communications network, in accordance with the present disclosure.

FIG. 5 is a diagram illustrating an example associated with semi-statically configuring a slot, in accordance with the present disclosure.

FIG. 6 is a diagram illustrating an example associated with configurations for downlink (DL)-only communication states, in accordance with the present disclosure.

FIG. 7 is a diagram illustrating an example associated with configurations for uplink (UL)-only configuration states, in accordance with the present disclosure.

FIG. 8 is a diagram illustrating an example associated with communication during DL-only or UL-only states, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram illustrating an example process performed, for example, by a network node, in accordance with the present disclosure.

FIG. 13 is a diagram illustrating an example of an implementation of code and circuitry for a communications device, in accordance with the present disclosure.

FIG. 14 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for communication during downlink-only or uplink-only states.

A user equipment (UE) is generally configured for both downlink (DL) and uplink (UL) communication with a network entity (sometimes called a network node). “DL communication” generally refers to communications from the network entity to the UE. “UL communication” generally refers to a communication from the UE to the network entity. DL and UL communications are typically configured to occur at different times to reduce interference and increase the likelihood of the communications reaching the intended targets.

The network entity may periodically operate in a low energy state to reduce power consumption. When the network entity is operating in a low energy state, however, it may not transmit certain DL communications or be able to receive certain UL communications. If the network entity is not transmitting DL communications or receiving UL communications, the slots or symbols dedicated to those communications may go unused. By allowing the UE to dynamically repurpose unused slots or symbols (e.g., by treating unused UL slots or symbols as DL slots or symbols and unused DL slots or symbols as UL slots or symbols), the UE and network entity can increase network efficiency while being able to implement low energy states. For example, when the network node operates in a low energy state that triggers the UE to operate in a DL-only state, the UE will not spend time or energy transmitting UL communications. Similarly, when the network node operates in a low energy state that triggers the UE to operate in a UL-only state, the UE will not spend time or energy searching for DL communications from the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

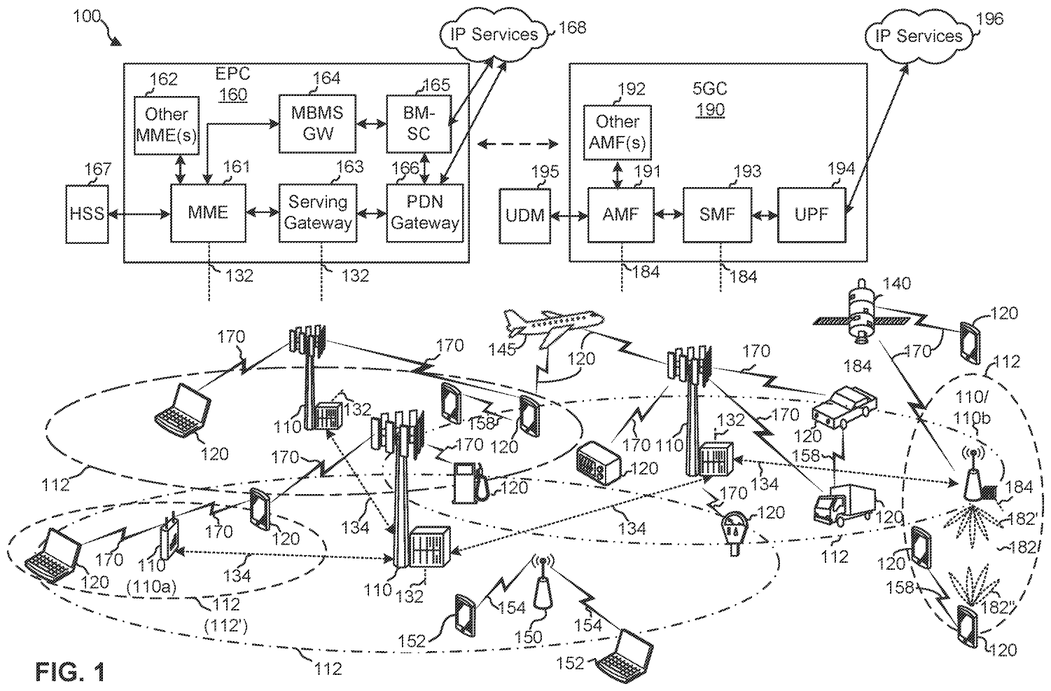

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry UL (also referred to as reverse link) transmissions from a UE 120 to a BS 110 and/or DL (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (CNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

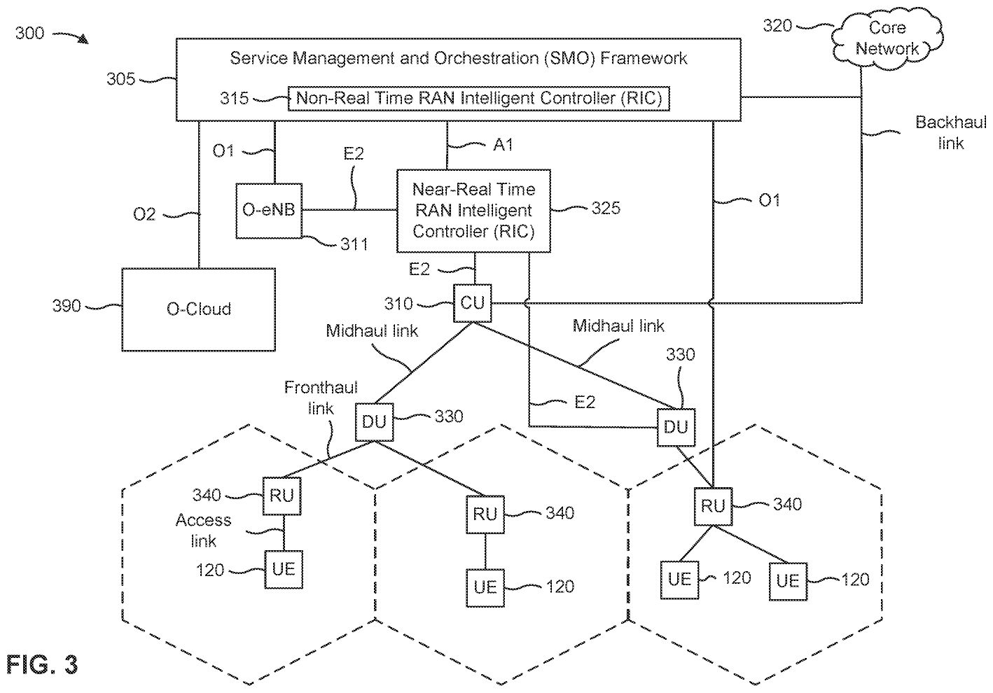

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a sub-band. For example, 3GPP currently defines Frequency Range 1 (FR1) as including 410 MHz-7125 MHz, which is often referred to (interchangeably) as “Sub-6 GHZ”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

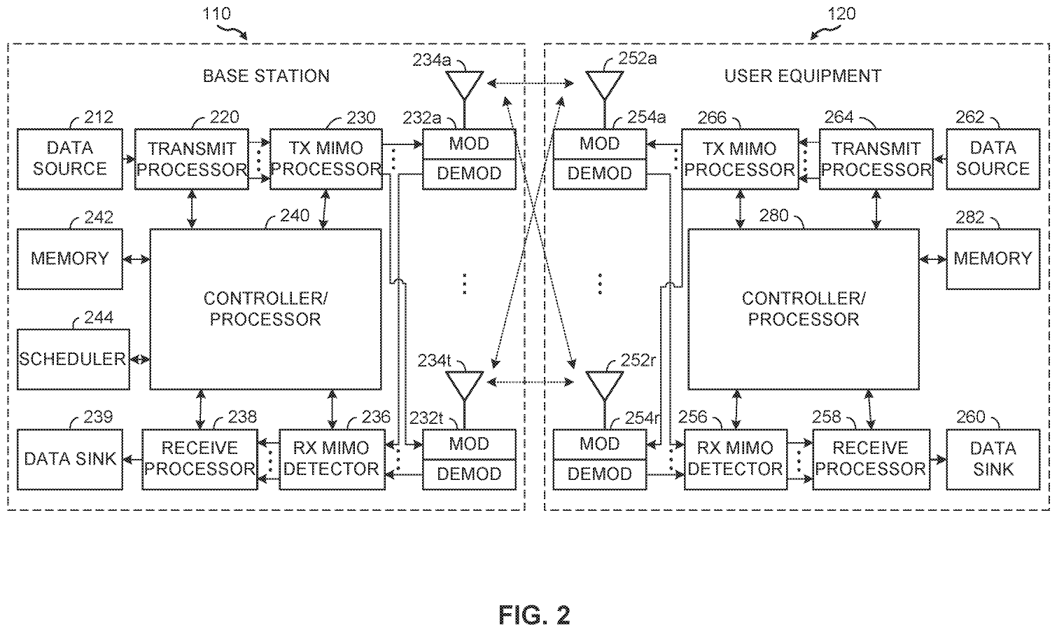

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an 02 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

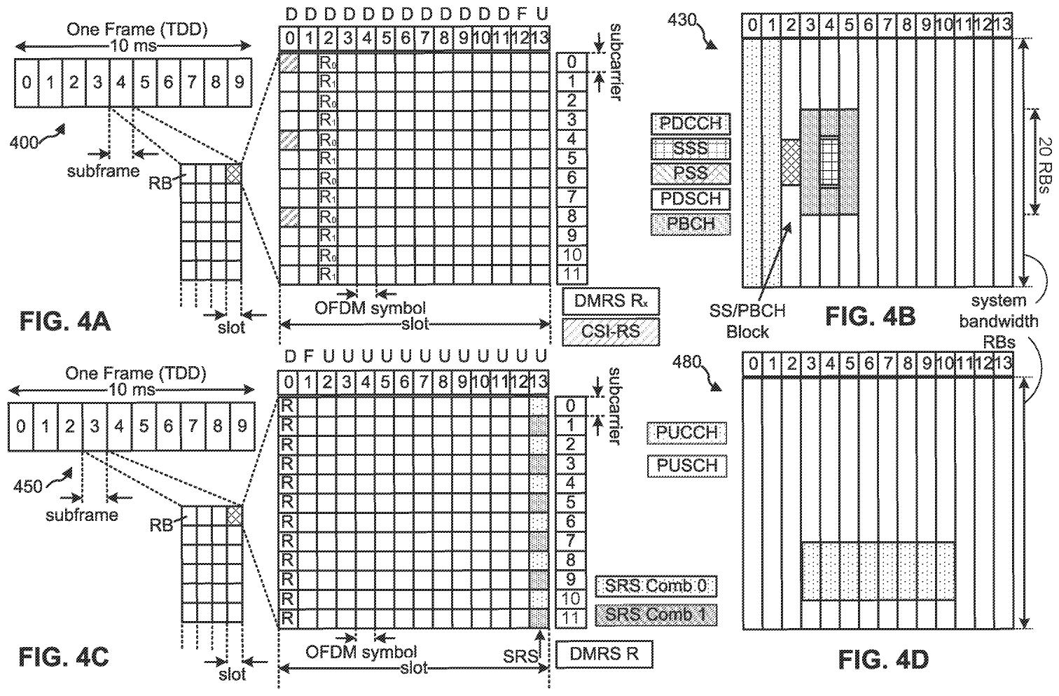

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgement (ACK)/negative ACK (ACK/NACK) feedback. The PUSCH carries data, and may additionally be used to carry a buffer status report (BSR), a power headroom report (PHR), and/or UCI.

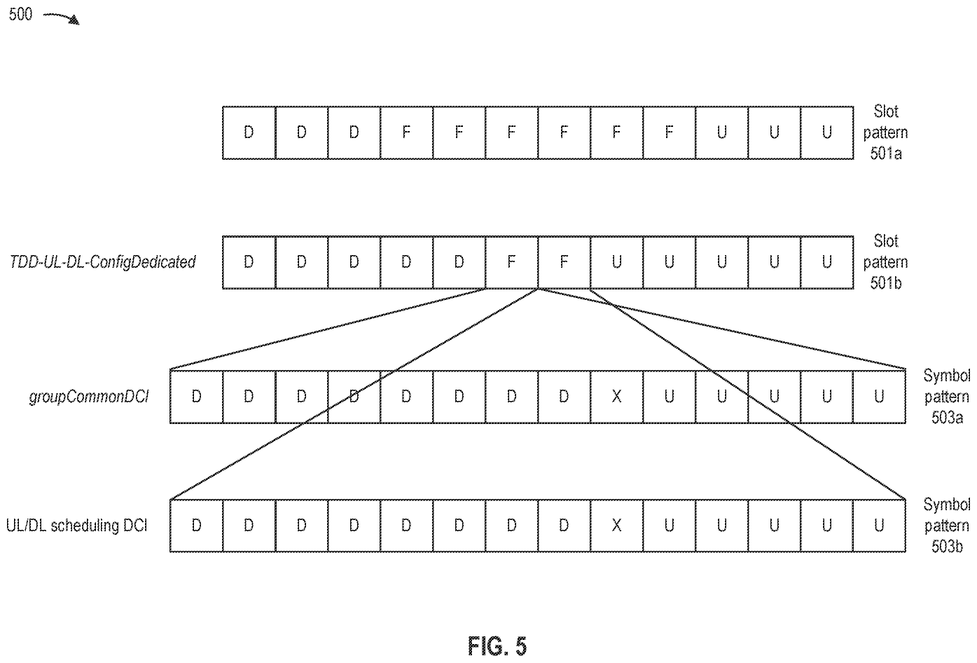

FIG. 5 is a diagram illustrating an example 500 associated with semi-statically configuring a slot, in accordance with the present disclosure. Example 500 includes communication between a BS 110 and a UE 120. In some aspects, BS 110 and UE 120 may be included in a wireless network, such as wireless network 100. BS 110 and UE 120 may communicate via a wireless access link, which may include an uplink and a downlink.

The BS 110 may configure slots, for the UE 120 to use for uplink or downlink, using a combination of RRC messages and DCI. In example 500, the BS 110 may configure slots with a periodicity of twelve such that a pattern of slots repeats every twelve slots. For example, an initial slot pattern 501a (three downlink slots followed by six flexible slots followed by three uplink slots, in example 500) may be configured using a TDD-UL-DL-ConfigCommon data structure (e.g., as defined in 3GPP specifications and/or another standard) and/or other similar data structure in an RRC message. Additionally, in some aspects, the initial pattern 501a may be refined to slot pattern 501b (five downlink slots followed by two flexible slots followed by five uplink slots, in example 500) using a TDD-UL-DL-ConfigDedicated data structure (e.g., as defined in 3GPP specifications and/or another standard) and/or other similar data structure in another RRC message. In some aspects, remaining flexible slots may be divided between downlink and uplink symbols (optionally including one or more guard symbols shown as “X” symbols between downlink and uplink symbols) using DCI. For example, as shown in FIG. 5, the BS 110 may use groupCommonDCI (e.g., as defined in 3GPP specifications and/or another standard) to divide the first flexible slot according to symbol pattern 503a remaining and use scheduling DCI (e.g., for dynamic scheduling) to divide the second flexible slot according to symbol pattern 503b.

As indicated above, FIG. 5 is provided as an example. Other examples may differ from what is described with respect to FIG. 5.

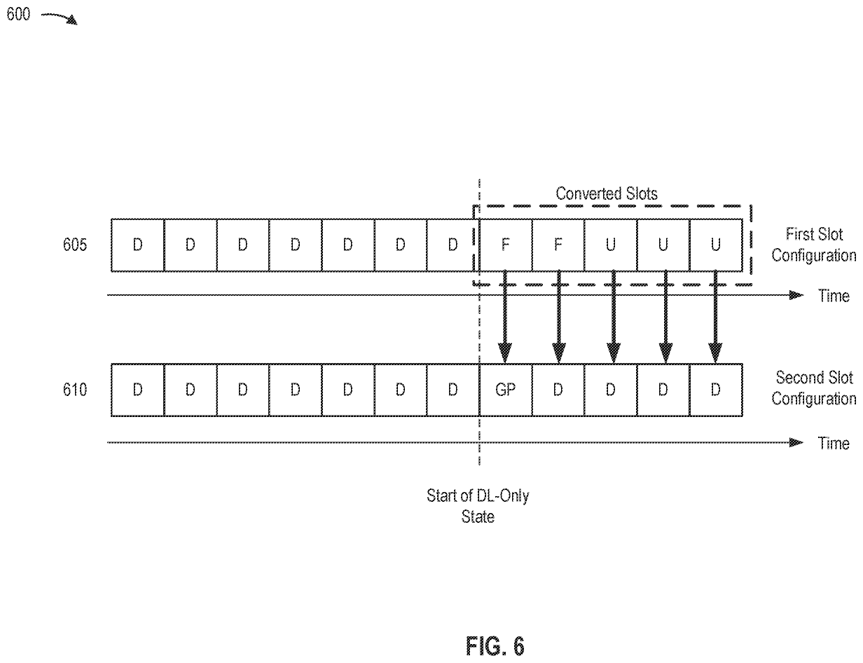

FIG. 6 is a diagram illustrating an example 600 associated with configurations for DL-only communication states, in accordance with the present disclosure. As shown in FIG. 6, example 600 includes communication between a BS 110 and a UE 120. In some aspects, BS 110 and UE 120 may be included in a wireless network, such as wireless network 100. BS 110 and UE 120 may communicate via a wireless access link, which may include an uplink and a downlink.

As shown in FIG. 6, the UE 120 may be configured with a first slot configuration 605 having DL, UL, and flexible slots. The UE 120 may receive signaling indicating that the BS 110 is operating in (or will be operating in) a low energy state. As a result of the signaling indicating that the BS 110 is or will be operating in the low energy state, the UE 120 may apply a second slot configuration 610.

In some aspects, such as when the low energy state indicates a DL-only state, the UE 120 may treat one or more of the UL slots as DL slots when applying the second slot configuration 610. In some aspects, the UE 120 may treat one or more of the flexible slots as DL slots when applying the second slot configuration 610. In some aspects, the UE 120 may treat one or more slots, such as the first slot after receiving the signaling indicating the transition of the BS 110 to the low energy mode, as a guard period (GP) slot to, for example, reduce interference that may occur when switching slot types.

Accordingly, the UL slots overlapping with the DL-only state may be treated by the UE 120 as DL slots to receive DL frames. Doing so may help during low latency applications where the UE 120 is expecting a burst of data packets. The indication of the DL-only state may implicitly indicate dynamic switching of UL slots to DL slots that overlap with the DL-only state duration.

In some aspects, rather than treat the UL slots as DL slots during the low energy (e.g., DL-only state), the UE 120 may be configured to enter a sleep state. In some aspects, the sleep state may be based, at least in part, on the duration of sleep available to the UE 120. For example, if the low energy state is expected to last 1 ms, the UE 120 may enter a microsleep state. If the low energy state is expected to last 2 ms or more, the UE 120 may enter a light sleep state.

Alternatively, the UE 120 may be configured to treat the UL slots as UL slots but only transmit certain communications, such as a scheduling request, HARQ

ACK/NACK feedback, or configured grant transmissions during the UL slots while the BS 110 is operating in the low energy state.

The operation of the UE 120 discussed with respect to example 600 may be based on configurations and/or signaling received from the BS 110. Moreover, the UE 120 may be configured with default configurations for additional DL slots (e.g., UL slots converted into or otherwise treated as DL slots). For example, in some aspects, the UE 120 may be configured to apply the configuration of a previous DL slot to the additional DL slots. In some aspects, the UE 120 may be configured to apply the same control resource set (CORESET) (e.g., number of resource blocks and symbols, among other examples) to the additional DL slots as applied to the previous or initial DL slots. In some aspects, the UE 120 may be configured with specific configurations for additional DL slots, and the specific configurations for the additional DL slots may be the same or different from the configurations for the initial DL slots. In some aspects, the UE 120 may be configured with a specific DL bandwidth part (BWP) for the additional DL slots, and the configurations for the additional DL slots may be included in the specific DL BWP.

In some aspects, the UE 120 may be configured to treat sub-band full duplex (SBFD) and in-band full duplex (IBFD) slots as DL slots when the BS 110 is operating in the low energy state. In some aspects, the UE 120 may be configured to convert the entire SBFD or IBFD band to a DL slot. In some aspects, the UE 120 may be configured to communicate only on the DL sub-band of the SBFD or IBFD when the BS 110 is operating in the low energy state.

As indicated above, FIG. 6 is provided as an example. Other examples may differ from what is described with respect to FIG. 6.

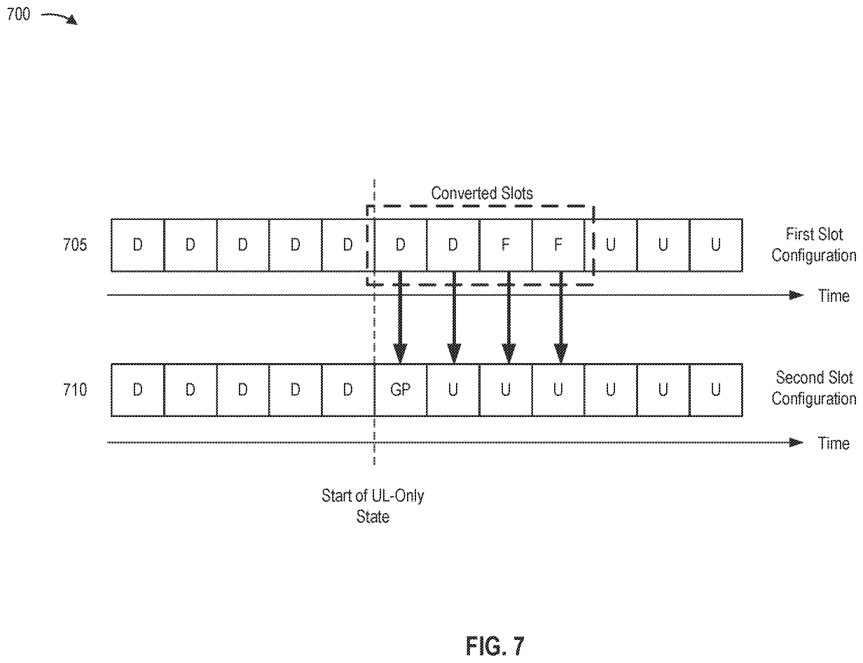

FIG. 7 is a diagram illustrating an example 700 associated with configurations for UL-only configuration states, in accordance with the present disclosure. As shown in FIG. 7, example 700 includes communication between a BS 110 and a UE 120. In some aspects, BS 110 and UE 120 may be included in a wireless network, such as wireless network 100. BS 110 and UE 120 may communicate via a wireless access link, which may include an uplink and a downlink.

As shown in FIG. 7, the UE 120 may be configured with a first slot configuration 705 having DL, UL, and flexible slots. The UE 120 may receive signaling indicating that the BS 110 is operating in (or will be operating in) a low energy state. As a result of the signaling indicating that the BS 110 is or will be operating in the low energy state, the UE 120 may apply a second slot configuration 710.

In some aspects, such as when the low energy state indicates a UL-only state, the UE 120 may treat one or more of the DL slots as UL slots when applying the second slot configuration 710. In some aspects, the UE 120 may treat one or more of the flexible slots as UL slots when applying the second slot configuration 710. In some aspects, the UE 120 may treat one or more slots, such as the first slot after receiving the signaling indicating the transition of the BS 110 to the low energy mode, as a GP slot to, for example, reduce interference that may occur when switching slot types.

In some aspects, rather than treat the DL slots as UL slots during the low energy (e.g., UL-only state), the UE 120 may be configured to enter a sleep state. In some aspects, the sleep state may be based, at least in part, on the value of sleep available to the UE 120. For example, if the low energy state is expected to last 1 ms, the UE 120 may enter a microsleep state. If the low energy state is expected to last 2 ms or more, the UE 120 may enter a light sleep state.

The operation of the UE 120 discussed with respect to example 700 may be based on configurations and/or signaling received from the BS 110. Moreover, the UE 120 may be configured with default configurations for additional UL slots (e.g., DL slots converted into or otherwise treated as UL slots). For example, in some aspects, the UE 120 may be configured to apply the configuration of a previous UL slot to the additional UL slots. In some aspects, the UE 120 may be configured to apply the same CORESET (e.g., number of resource blocks and symbols, among other examples) to the additional UL slots as applied to the previous or initial UL slots. In some aspects, the UE 120 may be configured with specific configurations for additional UL slots, and the specific configurations for the additional UL slots may be the same or different from the configurations for the initial UL slots. In some aspects, the UE 120 may be configured with a specific UL BWP for the additional UL slots, and the configurations for the additional UL slots may be included in the specific UL BWP.

In some aspects, the UE 120 may be configured to treat SBFD and IBFD slots as UL slots when the BS 110 is operating in the low energy state. In some aspects, the UE 120 may be configured to convert the entire SBFD or IBFD band to a UL slot. In some aspects, the UE 120 may be configured to communicate only on the UL sub-band of the SBFD or IBFD when the BS 110 is operating in the low energy state.

As indicated above, FIG. 7 is provided as an example. Other examples may differ from what is described with respect to FIG. 7.

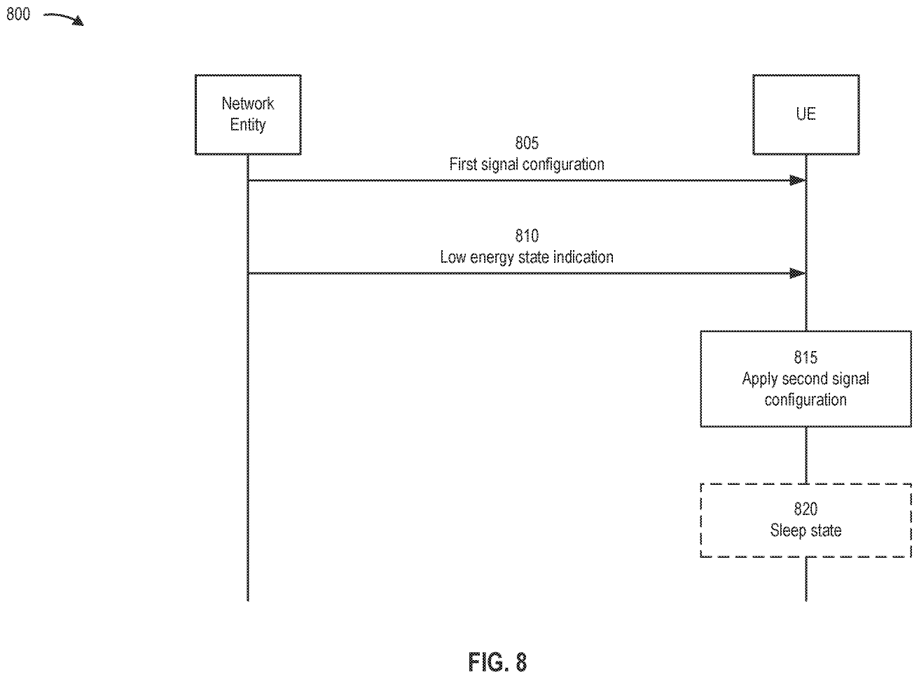

FIG. 8 is a diagram illustrating an example 800 associated with communication during DL-only or UL-only states, in accordance with the present disclosure. As shown in FIG. 8, a network entity (such as BS 110) and a UE (such as UE 120) may communicate with one another.

As shown by reference number 805, the network entity may transmit, and the UE may receive, a first signal configuration. The first signal configuration may indicate one or more initial DL slots or symbols and one or more initial UL slots or symbols. In some aspects, the first signal configuration may indicate one or more flexible slots or symbols. In some aspects, one or more of the initial DL slots or symbols and/or one or more of the initial UL slots or symbols are included in SBFD or IBFD slots or symbols. In some aspects, the first signal configuration indicates a first CORESET configuration for the initial DL slots or symbols, the initial UL slots or symbols, the flexible slots or symbols, and/or a combination thereof, among other examples. In some aspects, the first signal configuration indicates a first BWP configuration for the initial DL slots or symbols, the initial UL slots or symbols, the flexible slots or symbols, and/or a combination thereof, among other examples. In some aspects, the first signal configuration may be based, at least in part, on a slot format indicator (SFI) transmitted from the network entity and received by the UE. In some aspects, the first signal configuration may include one or more common configured slots, one or more dedicated configured slots, or one or more slots indicated by the SFI, among other examples.

As shown by reference number 810, the network entity may transmit, and the UE may receive, signaling indicating a transition of the network entity to a low energy state. The signaling may indicate that the network entity is going to transition to the low energy state at a specified time. Alternatively, the signaling may indicate that the network entity has transitioned to the low energy state. In some aspects, the signaling indicating the transition of the network entity to a low energy state may include a second signal configuration, discussed below.

As shown by reference number 815, the UE may apply the second signal configuration. In some aspects, the second signal configuration includes one or more common configured slots, one or more dedicated configured slots, or one or more slots indicated by the SFI. In some aspects, the second signal configuration may be applied as a result of receiving the signaling indicating the transition of the network entity to the low energy state. In some aspects, the second signal configuration may be received at the UE from the network entity via signaling separate from the signaling indicating the transition of the network entity to the low energy state.

In some aspects, by applying the second signal configuration, one or more of the initial UL slots or symbols may be converted to or otherwise treated as additional DL slots or symbols. In some aspects, applying the second signal configuration may include applying the first CORESET configuration to the initial UL slots or symbols converted into additional DL slots or symbols. In some aspects, applying the second signal configuration may include applying a second CORESET configuration, different from the first CORESET configuration, to the initial UL slots or symbols converted into additional DL slots or symbols. In some aspects, applying the second signal configuration may include applying the first BWP configuration to the initial UL slots or symbols converted into additional DL slots or symbols. In some aspects, applying the second signal configuration may include applying a second BWP configuration, different from the first BWP configuration, to the initial UL slots or symbols converted into additional DL slots or symbols. In some aspects, by applying the second signal configuration, one or more initial flexible slots or symbols may be converted to or otherwise treated as supplemental DL slots or symbols, and the additional DL slots or symbols may include the supplemental DL slots or symbols. In some aspects, applying the second signal configuration may include limiting UL communication between the UE and the network entity to only UL communications of a predefined communication type. In some aspects, the predefined communication type may include one or more of a scheduling request, HARQ ACK/NACK feedback, or configured grant transmissions during the initial UL slots. In some aspects, applying the second signal configuration may include converting the one or more SBFD slots or the one or more IBFD slots into the supplemental DL slots, wherein the additional DL slots or symbols include the supplemental DL slots. In some aspects, converting the one or more SBFD slots or the one or more IBFD slots may include converting an entirety of each of the one or more SBFD slots or the one or more IBFD slots into the supplemental DL slots. In some aspects, converting the one or more SBFD slots or the one or more IBFD slots into the supplemental DL slots may include converting one or more UL sub-bands of the SBFD slots or the one or more IBFD slots into one or more DL sub-bands.

Alternatively, in some aspects, by applying the second signal configuration, one or more of the initial DL slots or symbols may be converted to or otherwise treated as additional UL slots or symbols. In some aspects, applying the second signal configuration may include applying the first CORESET configuration to the initial DL slots or symbols converted into additional UL slots or symbols. In some aspects, applying the second signal configuration may include applying a second CORESET configuration, different from the first CORESET configuration, to the initial DL slots or symbols converted into additional UL slots or symbols. In some aspects, applying the second signal configuration may include applying the first BWP configuration to the initial DL slots or symbols converted into additional UL slots or symbols. In some aspects, applying the second signal configuration may include applying a second BWP configuration, different from the first BWP configuration, to the initial DL slots or symbols converted into additional UL slots or symbols. In some aspects, by applying the second signal configuration, one or more initial flexible slots or symbols may be converted to or otherwise treated as supplemental UL slots or symbols, and the additional UL slots or symbols may include the supplemental UL slots or symbols. In some aspects, applying the second signal configuration may include converting one or more SBFD slots or one or more IBFD slots into supplemental UL slots, wherein the additional UL slots or symbols include the supplemental UL slots. In some aspects, converting the one or more SBFD slots or the one or more IBFD slots may include converting an entirety of each of the one or more SBFD slots or the one or more IBFD slots into the supplemental UL slots. In some aspects, converting the one or more SBFD slots or the one or more IBFD slots into the supplemental UL slots may include converting one or more DL sub-bands of the SBFD slots or the one or more IBFD slots into one or more UL sub-bands.

As shown by reference number 820, the UE may transition to a sleep state as a result of the signaling indicating the transition of the network entity to the low energy state. The UE may be configured to transition to the sleep mode during some or all of the time the network entity is operating in the low energy mode. Therefore, in some aspects, the UE may apply the second signal configuration to convert some of the initial UL slots or symbols to additional DL slots or symbols (or initial DL slots or symbols into additional UL slots or symbols) before entering the sleep mode. In some aspects, the UE may enter the sleep mode without applying the second signal configuration.

As indicated above, FIG. 8 is provided as an example. Other examples may differ from what is described with respect to FIG. 8.

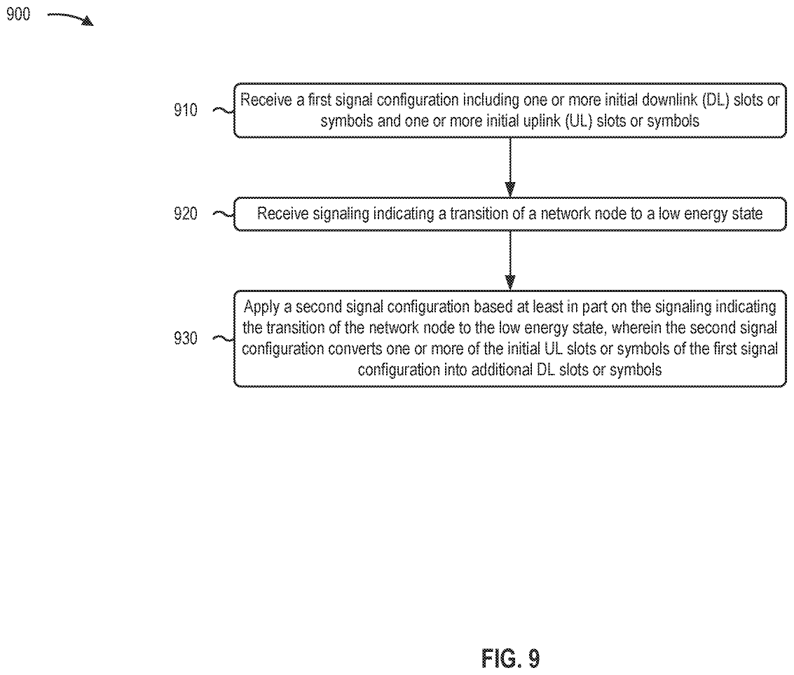

FIG. 9 shows a method 900 for wireless communications by a UE, such as UE 120.

Method 900 begins at 910 with receiving a first signal configuration including one or more initial DL slots or symbols and one or more initial UL slots or symbols.

Method 900 then proceeds to step 920 with receiving signaling indicating a transition of a network node to a low energy state.

Method 900 then proceeds to step 930 with applying a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

In one aspect, the first signal configuration includes a first CORESET configuration for the one or more initial DL slots or symbols, and applying the second signal configuration includes applying the first CORESET configuration to the additional DL slots or symbols.

In one aspect, the first signal configuration includes a first CORESET configuration for the one or more initial DL slots or symbols, and applying the second signal configuration includes applying a second CORESET configuration to the additional DL slots or symbols.

In one aspect, the first signal configuration includes a first BWP configuration for the one or more initial DL slots or symbols, and applying the second signal configuration includes applying a second BWP configuration to the additional DL slots or symbols.

In one aspect, the first signal configuration includes one or more flexible slots or symbols, and applying the second signal configuration includes converting each of the one or more flexible slots or symbols into supplemental DL slots or symbols, wherein the additional DL slots or symbols include the supplemental DL slots or symbols.

In one aspect, method 900 further includes transitioning to a sleep state as a result of the signaling indicating the transition of the network node to the low energy state.

In one aspect, the sleep state occurs during the one or more additional DL slots or symbols or during the one or more initial UL slots or symbols.

In one aspect, applying the second signal configuration includes limiting communication during the one or more initial UL slots or symbols to a communication type.

In one aspect, the communication type includes one or more of a scheduling request, a hybrid automatic repeat request, or a configured grant.

In one aspect, the signaling indicating the transition of the network node to the low energy state includes the second signal configuration.

In one aspect, method 900 further includes receiving, from a network entity, the second signal configuration.

In one aspect, applying the second signal configuration includes converting one or more SBFD slots or one or more IBFD slots into supplemental DL slots, wherein the additional DL slots or symbols include the supplemental DL slots.

In one aspect, converting the one or more SBFD slots or the one or more IBFD slots into the supplemental DL slots includes converting an entirety of each of the one or more SBFD slots or the one or more IBFD slots into the supplemental DL slots.

In one aspect, converting the one or more SBFD slots or the one or more IBFD slots into the supplemental DL slots includes converting one or more UL sub-bands of the SBFD slots or the one or more IBFD slots into one or more DL sub-bands.

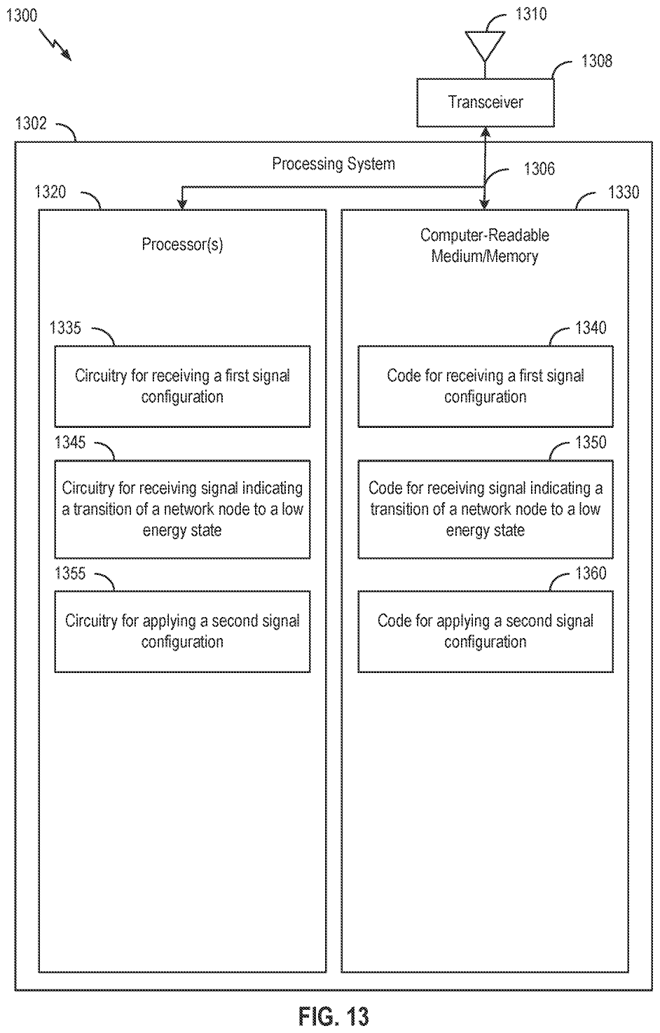

In one aspect, method 900, or any aspect related to it, may be performed by an apparatus, such as communications device 1300 of FIG. 13, which includes various components operable, configured, or adapted to perform the method 900. Communications device 1300 is described below in further detail.

Note that FIG. 9 is just one example of a method, and other methods including fewer, additional, or alternative steps are possible consistent with this disclosure.

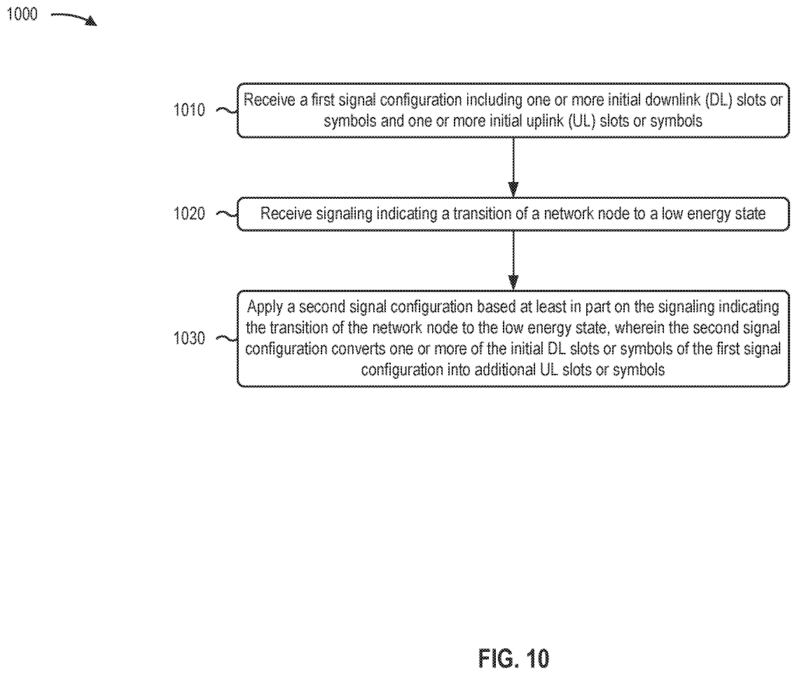

FIG. 10 shows a method 1000 for wireless communications by a UE, such as UE 120.

Method 1000 begins at 1010 with receiving a first signal configuration including one or more initial DL slots or symbols and one or more initial UL slots or symbols.

Method 1000 then proceeds to step 1020 with receiving signaling indicating a transition of a network node to a low energy state.

Method 1000 then proceeds to step 1030 with applying a second signal configuration based at least in part on the signaling indicating the transition of the network node to the low energy state, wherein the second signal configuration converts the one or more of the initial DL slots or symbols of the first signal configuration into the additional UL slots or symbols.

In one aspect, the first signal configuration includes a first CORESET configuration for the one or more initial UL slots or symbols, and applying the second signal configuration includes applying the first CORESET configuration to the additional UL slots or symbols.

In one aspect, the first signal configuration includes a first CORESET configuration for the one or more initial UL slots or symbols, and applying the second signal configuration includes applying a second CORESET configuration to the additional UL slots or symbols.

In one aspect, the first signal configuration includes a first BWP configuration for the one or more initial UL slots or symbols, and applying the second signal configuration includes applying a second BWP configuration to the the additional UL slots or symbols.

In one aspect, the first signal configuration includes one or more flexible slots or symbols, and applying the second signal configuration includes converting each of the one or more flexible slots or symbols into supplemental UL slots or symbols, wherein the additional UL slots or symbols include the supplemental UL slots or symbols.

In one aspect, method 1000 further includes transitioning to a sleep state as a result of the signaling indicating the transition of the network node to the low energy state.

In one aspect, the sleep state occurs during the one or more additional UL slots or symbols or during the one or more initial DL slots or symbols.

In one aspect, the signaling indicating the transition of the network node to the low energy state includes the second signal configuration.

In one aspect, method 1000 further includes receiving, from a network entity, the second signal configuration.

In one aspect, applying the second signal configuration includes converting one or more SBFD slots or one or more IBFD slots into supplemental UL slots, wherein the additional UL slots or symbols include the supplemental UL slots.

In one aspect, converting the one or more SBFD slots or the one or more IBFD slots into the supplemental UL slots includes converting an entirety of each of the one or more SBFD slots or the one or more IBFD slots into the supplemental UL slots.

In one aspect, converting the one or more SBFD slots or the one or more IBFD slots into the supplemental UL slots includes converting one or more DL sub-bands of the SBFD slots or the one or more IBFD slots into one or more UL sub-bands.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

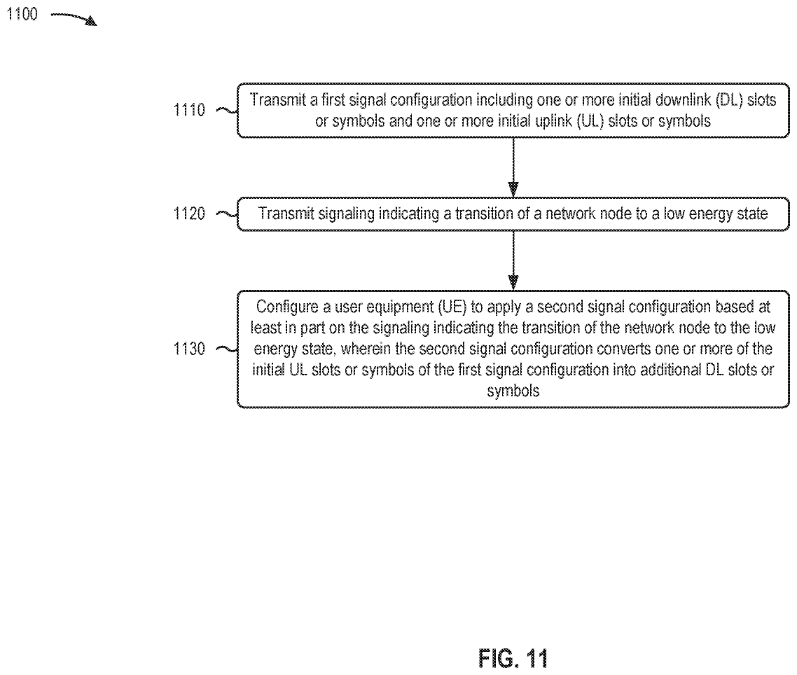

FIG. 11 shows a method 1100 for wireless communications by a network entity, such as BS 110, or a disaggregated base station as discussed with respect to FIG. 3.

Method 1100 begins at 1110 with transmitting a first signal configuration including one or more initial DL slots or symbols and one or more initial UL slots or symbols.

Method 1100 then proceeds to step 1120 with transmitting signaling indicating a transition of a network node to a low energy state.

Method 1100 then proceeds to step 1130 with configuring a UE to apply a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

In one aspect, the first signal configuration includes a first CORESET configuration for the one or more initial DL slots or symbols, and applying the second signal configuration includes applying the first CORESET configuration to the additional DL slots or symbols.

In one aspect, the first signal configuration includes a first CORESET configuration for the one or more initial DL slots or symbols, and applying the second signal configuration includes applying a second CORESET configuration to the additional DL slots or symbols.

In one aspect, the first signal configuration includes a first BWP configuration for the one or more initial DL slots or symbols, and applying the second signal configuration includes applying a second BWP configuration to the the additional DL slots or symbols.

In one aspect, the first signal configuration includes one or more flexible slots or symbols, and applying the second signal configuration includes converting each of the one or more flexible slots or symbols into supplemental DL slots or symbols, wherein the additional DL slots or symbols include the supplemental DL slots or symbols.

In one aspect, method 1100 further includes configuring the UE to transition to a sleep state as a result of the signaling indicating the transition of the network node to the low energy state.

In one aspect, the sleep state occurs during the one or more additional DL slots or symbols or during the one or more initial UL slots or symbols.

In one aspect, configuring the UE to apply the second signal configuration includes limiting communication during the one or more initial UL slots or symbols to a communication type.

In one aspect, the communication type includes one or more of a scheduling request, a hybrid automatic repeat request, or a configured grant.

In one aspect, the signaling indicating the transition of the network node to the low energy state includes the second signal configuration.

In one aspect, method 1100 further includes transmitting the second signal configuration to the UE.

In one aspect, configuring the UE to apply the second signal configuration includes configuring the UE to convert one or more SBFD slots or one or more IBFD slots into additional DL slots.

In one aspect, configuring the UE to convert one or more SBFD slots or IBFD slots into additional DL slots includes configuring the UE to convert an entirety of each of the one or more SBFD slots or IBFD slots into additional DL slots.

In one aspect, configuring the UE to convert one or more SBFD slots or IBFD slots into additional DL slots includes converting one or more UL sub-bands into one or more DL sub-bands.

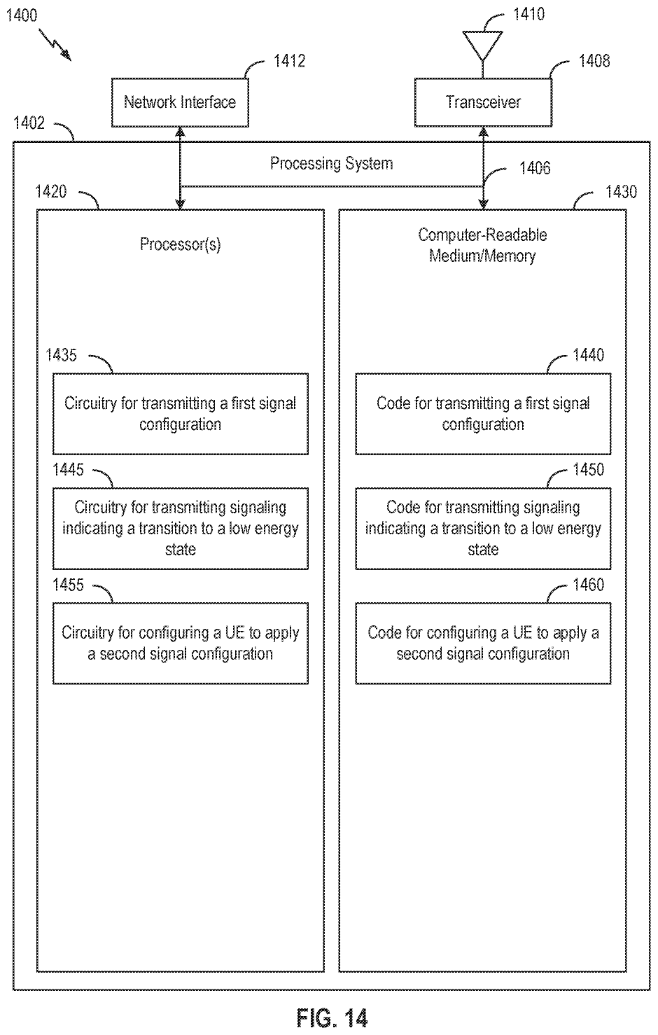

In one aspect, method 1100, or any aspect related to it, may be performed by an apparatus, such as communications device 1400 of FIG. 14, which includes various components operable, configured, or adapted to perform the method 1100.

Communications device 1400 is described below in further detail.

Note that FIG. 11 is just one example of a method, and other methods including fewer, additional, or alternative steps are possible consistent with this disclosure.

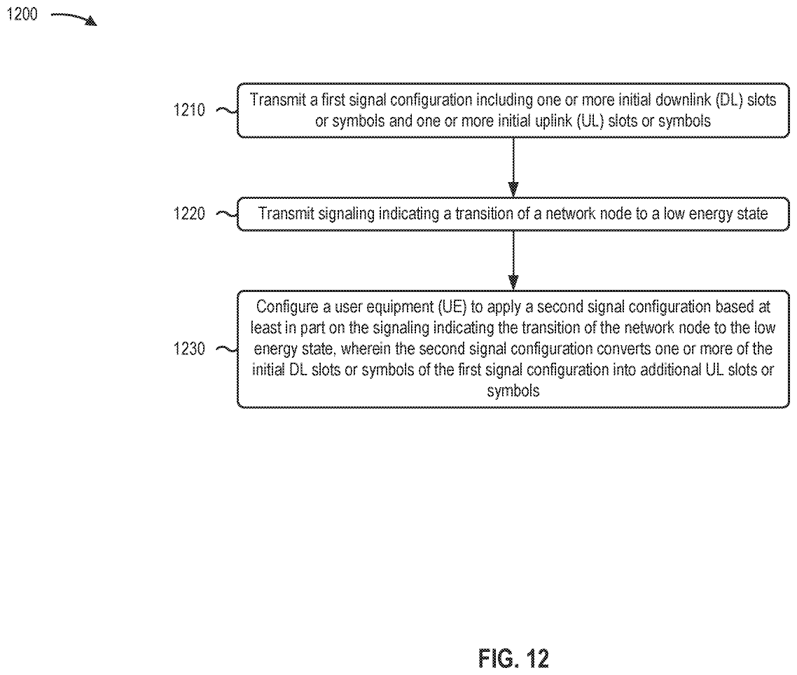

FIG. 12 shows a method 1200 for wireless communications by a network entity, such as BS 110, or a disaggregated base station as discussed with respect to FIG. 3.

Method 1200 begins at 1210 with transmitting a first signal configuration including one or more initial DL slots or symbols and one or more initial UL slots or symbols.

Method 1200 then proceeds to step 1220 with transmitting signaling indicating a transition of a network node to a low energy state.

Method 1200 then proceeds to step 1230 with configuring a UE to apply a second signal configuration based at least in part on the signaling indicating the transition of the network node to the low energy state. In some aspects, the second signal configuration converts the one or more of the initial DL slots or symbols of the first signal configuration into the additional UL slots or symbols.

In one aspect, the first signal configuration includes a first CORESET configuration for the one or more initial UL slots or symbols, and applying the second signal configuration includes applying the first CORESET configuration to the additional UL slots or symbols.

In one aspect, the first signal configuration includes a first CORESET configuration for the one or more initial UL slots or symbols, and applying the second signal configuration includes applying a second CORESET configuration to the additional UL slots or symbols.

In one aspect, the first signal configuration includes a first BWP configuration for the one or more initial UL slots or symbols, and applying the second signal configuration includes applying a second BWP configuration to the the additional UL slots or symbols.

In one aspect, the first signal configuration includes one or more flexible slots or symbols, and applying the second signal configuration includes converting each of the one or more flexible slots or symbols into supplemental UL slots or symbols, wherein the additional UL slots or symbols include the supplemental UL slots or symbols.

In one aspect, method 1200 further includes configuring the UE to transition to a sleep state as a result of the signaling indicating the transition of the network node to the low energy state.

In one aspect, the sleep state occurs during the one or more additional UL slots or symbols or during the one or more initial DL slots or symbols.

In one aspect, the signaling indicating the transition of the network node to the low energy state includes the second signal configuration.

In one aspect, method 1200 further includes transmitting the second signal configuration to the UE.

In one aspect, configuring the UE to apply the second signal configuration includes configuring the UE to convert one or more SBFD slots or one or more IBFD slots into additional UL slots.

In one aspect, configuring the UE to convert one or more SBFD slots or IBFD slots into additional UL slots includes configuring the UE to convert an entirety of each of the one or more SBFD slots or IBFD slots into the additional UL slot.

In one aspect, configuring the UE to convert one or more SBFD slots or IBFD slots into additional UL slots includes configuring the UE to convert one or more DL sub-bands into one or more UL sub-bands.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

FIG. 13 is a diagram illustrating an example of an implementation of code and circuitry for a communications device 1300, in accordance with the present disclosure. The communications device 1300 may be a UE, or a UE may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may be representative of memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 900 described with respect to FIG. 9 and/or the method 1000 described with respect to FIG. 10, or any aspects related to them. Note that reference to a processor performing a function of communications device 1300 may include one or more processors performing that function of communications device 1300.

As shown in FIG. 13, the communications device 1300 may include circuitry for receiving a first signal configuration including one or more initial DL slots or symbols and one or more initial UL slots or symbols (circuitry 1335).

As shown in FIG. 13, the communications device 1300 may include, stored in computer-readable medium/memory 1330, code for receiving a first signal configuration including one or more initial DL slots or symbols and one or more initial UL slots or symbols (code 1340).

As shown in FIG. 13, the communications device 1300 may include circuitry for receiving signaling indicating a transition of a network node to a low energy state (circuitry 1345).

As shown in FIG. 13, the communications device 1300 may include, stored in computer-readable medium/memory 1330, code for receiving signaling indicating a transition of a network node to a low energy state (code 1350).

As shown in FIG. 13, the communications device 1300 may include circuitry for applying a second signal configuration based at least in part on the signaling indicating the transition of the network node to the low energy state (circuitry 1355). In some aspects, the second signal configuration converts the one or more initial UL slots or symbols into additional DL slots or symbols or the second signal configuration converts the one or more initial DL slots or symbols into additional UL slots or symbols. In some aspects, the second signal configuration converts one or more of the initial DL slots or symbols of the first signal configuration into additional UL slots or symbols.

As shown in FIG. 13, the communications device 1300 may include, stored in computer-readable medium/memory 1330, code for applying a second signal configuration based at least in part on the signaling indicating the transition of the network node to the low energy state (circuitry 1360). In some aspects, the second signal configuration converts the one or more initial UL slots or symbols into the additional DL slots or symbols. In some aspects, the second signal configuration converts the one or more initial DL slots or symbols into the additional UL slots or symbols.

Various components of the communications device 1300 may provide means for performing the method 900 described with respect to FIG. 9 and/or the method 1000 described with respect to FIG. 10, or any aspects related to them. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

FIG. 14 is a diagram illustrating an example of an implementation of code and circuitry for a communications device 1400, in accordance with the present disclosure. The communications device 1400 may be a network node (such as BS 110 or a disaggregated base station as described with regard to FIG. 3), or a network node may include the communications device 1400.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The network interface 1412 is configured to obtain and send signals for the communications device 1400 via communications link(s), such as a backhaul link, midhaul link, and/or fronthaul link as described herein, such as with respect to FIG. 3. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 238, transmit processor 220, TX MIMO processor 230, and/or controller/processor 240, as described with respect to FIG. 2. The one or more processors 1420 are coupled to a computer-readable medium/memory 1430 via a bus 1406. In various aspects, the computer-readable medium/memory 1430 may be representative of memory 242, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the methods 1100 described with respect to FIG. 11 and/or the method 1200 described with respect to FIG. 12, or any aspects related to them. Note that reference to a processor performing a function of communications device 1400 may include one or more processors performing that function of communications device 1400.

As shown in FIG. 14, the communications device 1400 may include circuitry for transmitting a first signal configuration including one or more initial DL slots or symbols and one or more initial UL slots or symbols (circuitry 1435).

As shown in FIG. 14, the communications device 1400 may include, stored in computer-readable medium/memory 1430, code for transmitting a first signal configuration including one or more initial DL slots or symbols and one or more initial UL slots or symbols (code 1440).

As shown in FIG. 14, the communications device 1400 may include circuitry for transmitting signaling indicating a transition of a network node to a low energy state (circuitry 1445).

As shown in FIG. 14, the communications device 1400 may include, stored in computer-readable medium/memory 1430, code for transmitting signaling indicating a transition of a network node to a low energy state (code 1450).

As shown in FIG. 14, the communications device 1400 may include circuitry for configuring a UE to apply a second signal configuration based at least in part on the signaling indicating the transition of the network node to the low energy state (circuitry 1455). In some aspects, the second signal configuration converts the one or more initial UL slots or symbols into additional DL slots or symbols. In some aspects, the second signal configuration converts the one or more initial DL slots or symbols into additional UL slots or symbols.

As shown in FIG. 14, the communications device 1400 may include, stored in computer-readable medium/memory 1430, code for configuring a UE to apply a second signal configuration based at least in part on the signaling indicating the transition of the network node to the low energy state (code 1460). In some aspects, the second signal configuration converts the one or more initial UL slots or symbols into the additional DL slots or symbols. In some aspects, the second signal configuration converts the one or more initial DL slots or symbols into the additional UL slots or symbols.

Various components of the communications device 1400 may provide means for performing the method 1100 described with respect to FIG. 11 and/or the method 1200 described with respect to FIG. 12, or any aspects related to them. For example, means for transmitting, sending, or outputting for transmission may include the transceiver(s) 232 and/or antenna(s) 234 of the BS 110 and/or transceiver 1408 and antenna 1410 of the communications device 1400 in FIG. 14. Means for receiving or obtaining may include the transceiver(s) 232 and/or antenna(s) 234 of the BS 110 and/or transceiver 1408 and antenna 1410 of the communications device 1400 in FIG. 14.

FIG. 14 is provided as an example. Other examples may differ from what is described in connection with FIG. 14.

The following provides an overview of some Aspects of the present disclosure:

Aspect 1: A method of wireless communication performed by a UE, comprising: receiving a first signal configuration including one or more initial DL slots or symbols and one or more initial UL slots or symbols; receiving signaling indicating a transition of a network node to a low energy state; and applying a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

Aspect 2: The method of claim 1, wherein the second signal configuration converts the one or more initial UL slots or symbols into the additional DL slots or symbols.

Aspect 3: The method of Aspect 2, wherein the first signal configuration includes a first CORESET configuration for the one or more initial DL slots or symbols, and wherein applying the second signal configuration includes applying the first CORESET configuration to the additional DL slots or symbols.

Aspect 4: The method of any of Aspects 2-3, wherein the first signal configuration includes a first CORESET configuration for the one or more initial DL slots or symbols, and wherein applying the second signal configuration includes applying a second CORESET configuration to the additional DL slots or symbols.

Aspect 5: The method of any of Aspects 2-4, wherein the first signal configuration includes a first BWP configuration for the one or more initial DL slots or symbols, and wherein applying the second signal configuration includes applying a second BWP configuration to the the additional DL slots or symbols.

Aspect 6: The method of any of Aspects 2-5, wherein the first signal configuration includes one or more flexible slots or symbols, and wherein applying the second signal configuration includes converting each of the one or more flexible slots or symbols into supplemental DL slots or symbols, wherein the additional DL slots or symbols include the supplemental DL slots or symbols.

Aspect 7: The method of any of Aspects 2-6, further comprising transitioning to a sleep state in response to the signaling indicating the transition of the network node to the low energy state.

Aspect 8: The method of Aspect 7, wherein the sleep state occurs during the one or more additional DL slots or symbols or during the one or more initial UL slots or symbols.

Aspect 9: The method of any of Aspects 2-8, wherein applying the second signal configuration includes limiting communication during the one or more initial UL slots or symbols to a communication type.

Aspect 10: The method of Aspect 9, wherein the communication type includes one or more of a scheduling request, a hybrid automatic repeat request, or a configured grant.

Aspect 11: The method of any of Aspects 2-10, wherein the signaling indicating the transition of the network node to the low energy state includes the second signal configuration.

Aspect 12: The method of any of Aspects 2-11, further comprising receiving, from a network entity, the second signal configuration.

Aspect 13: The method of any of Aspects 2-12, wherein applying the second signal configuration includes converting one or more SBFD slots or one or more IBFD slots into supplemental DL slots, wherein the additional DL slots or symbols include the supplemental DL slots.

Aspect 14: The method of Aspect 13, wherein converting the one or more SBFD slots or the one or more IBFD slots into the supplemental DL slots includes converting an entirety of each of the one or more SBFD slots or the one or more IBFD slots into the supplemental DL slots.

Aspect 15: The method of Aspect 13, wherein converting the one or more SBFD slots or the one or more IBFD slots into the supplemental DL slots includes converting one or more UL sub-bands of the SBFD slots or the one or more IBFD slots into one or more DL sub-bands.

Aspect 16: The method of Aspect 1, wherein the second signal configuration converts the one or more initial DL slots or symbols into the additional UL slots or symbols.

Aspect 17: The method of Aspect 16, wherein the first signal configuration includes a first CORESET configuration for the one or more initial UL slots or symbols, and wherein applying the second signal configuration includes applying the first CORESET configuration to the additional UL slots or symbols.

Aspect 18: The method of any of Aspects 16-17, wherein the first signal configuration includes a first CORESET configuration for the one or more initial UL slots or symbols, and wherein applying the second signal configuration includes applying a second CORESET configuration to the additional UL slots or symbols.

Aspect 19: The method of any of Aspects 16-18, wherein the first signal configuration includes a first BWP configuration for the one or more initial UL slots or symbols, and wherein applying the second signal configuration includes applying a second BWP configuration to the the additional UL slots or symbols.

Aspect 20: The method of any of Aspects 16-19, wherein the first signal configuration includes one or more flexible slots or symbols, and wherein applying the second signal configuration includes converting each of the one or more flexible slots or symbols into supplemental UL slots or symbols, wherein the additional UL slots or symbols include the supplemental UL slots or symbols.

Aspect 21: The method of any of Aspects 16-20 further comprising

transitioning to a sleep state in response to the signaling indicating the transition of the network node to the low energy state.

Aspect 22: The method of Aspect 21, wherein the sleep state occurs during the one or more additional UL slots or symbols or during the one or more initial DL slots or symbols.

Aspect 23: The method of any of Aspects 16-22, wherein the signaling indicating the transition of the network node to the low energy state includes the second signal configuration.

Aspect 24: The method of any of Aspects 16-23, further comprising receiving, from a network entity, the second signal configuration.

Aspect 25: The method of any of Aspects 16-24, wherein applying the second signal configuration includes converting one or more SBFD slots or one or more IBFD slots into supplemental UL slots, wherein the additional UL slots or symbols includes the supplemental UL slots.

Aspect 26: The method of Aspect 25, wherein converting the one or more SBFD slots or the one or more IBFD slots into the supplemental UL slots includes converting an entirety of each of the one or more SBFD slots or the one or more IBFD slots into the supplemental UL slots.

Aspect 27: The method of Aspect 25, wherein converting the one or more SBFD slots or the one or more IBFD slots into the supplemental UL slots includes converting one or more DL sub-bands of the SBFD slots or the one or more IBFD slots into one or more UL sub-bands.

Aspect 28: A method of wireless communication performed by a network node, comprising: transmitting a first signal configuration including one or more initial DL slots or symbols and one or more initial UL slots or symbols; transmitting signaling indicating a transition of a network node to a low energy state; and configuring a UE to apply a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

Aspect 29: The method of Aspect 28, wherein the second signal configuration converts the one or more initial UL slots or symbols into the additional DL slots or symbols.

Aspect 30: The method of Aspect 29, wherein the first signal configuration includes a first CORESET configuration for the one or more initial DL slots or symbols, and wherein applying the second signal configuration includes applying the first CORESET configuration to the additional DL slots or symbols.

Aspect 31: The method of any of Aspects 29-30, wherein the first signal configuration includes a first CORESET configuration for the one or more initial DL slots or symbols, and wherein applying the second signal configuration includes applying a second CORESET configuration to the additional DL slots or symbols.

Aspect 32: The method of any of Aspects 29-31, wherein the first signal configuration includes a first BWP configuration for the one or more initial DL slots or symbols, and wherein applying the second signal configuration includes applying a second BWP configuration to the the additional DL slots or symbols.

Aspect 33: The method of any of Aspects 29-32, wherein the first signal configuration includes one or more flexible slots or symbols, and wherein applying the second signal configuration includes converting each of the one or more flexible slots or symbols into supplemental DL slots or symbols, wherein the additional DL slots or symbols include the supplemental DL slots or symbols.

Aspect 34: The method of any of Aspects 29-33, further comprising configuring the UE to transition to a sleep state in response to the signaling indicating the transition of the network node to the low energy state.

Aspect 35: The method of Aspect 34, wherein the sleep state occurs during the one or more additional DL slots or symbols or during the one or more initial UL slots or symbols.

Aspect 36: The method of any of Aspects 29-35, wherein configuring the UE to apply the second signal configuration includes limiting communication during the one or more initial UL slots or symbols to a communication type.

Aspect 37: The method of Aspect 36, wherein the communication type includes one or more of a scheduling request, a hybrid automatic repeat request, or a configured grant.

Aspect 38: The method of any of Aspects 29-37, wherein the signaling indicating the transition of the network node to the low energy state includes the second signal configuration.

Aspect 39: The method of any of Aspects 29-38, further comprising transmitting the second signal configuration to the UE.

Aspect 40: The method of any of Aspects 29-39, wherein configuring the UE to apply the second signal configuration includes configuring the UE to convert one or more SBFD slots or one or more IBFD slots into additional DL slots.

Aspect 41: The method of Aspect 40, wherein configuring the UE to convert one or more SBFD slots or IBFD slots into additional DL slots includes configuring the UE to convert an entirety of each of the one or more SBFD slots or IBFD slots into additional DL slots.

Aspect 42: The method of Aspect 40, wherein configuring the UE to convert one or more SBFD slots or IBFD slots into additional DL slots includes converting one or more UL sub-bands into one or more DL sub-bands.

Aspect 43: The method of aspect 28, wherein the second signal configuration converts the one or more of the initial DL slots or symbols of the first signal configuration into the additional UL slots or symbols.

Aspect 44: The method of Aspect 43, wherein the first signal configuration includes a first CORESET configuration for the one or more initial UL slots or symbols, and wherein applying the second signal configuration includes applying the first CORESET configuration to the additional UL slots or symbols.

Aspect 45: The method of any of Aspects 43-44, wherein the first signal configuration includes a first CORESET configuration for the one or more initial UL slots or symbols, and wherein applying the second signal configuration includes applying a second CORESET configuration to the additional UL slots or symbols.

Aspect 46: The method of any of Aspects 43-45, wherein the first signal configuration includes a first BWP configuration for the one or more initial UL slots or symbols, and wherein applying the second signal configuration includes applying a second BWP configuration to the the additional UL slots or symbols.

Aspect 47: The method of any of Aspects 43-46, wherein the first signal configuration includes one or more flexible slots or symbols, and wherein applying the second signal configuration includes converting each of the one or more flexible slots or symbols into supplemental UL slots or symbols, wherein the additional UL slots or symbols include the supplemental UL slots or symbols.

Aspect 48: The method of any of Aspects 43-47, further comprising configuring the UE to transition to a sleep state in response to the signaling indicating the transition of the network node to the low energy state.

Aspect 49: The method of Aspect 48, wherein the sleep state occurs during the one or more additional UL slots or symbols or during the one or more initial DL slots or symbols.

Aspect 50: The method of any of Aspects 43-49, wherein the signaling indicating the transition of the network node to the low energy state includes the second signal configuration.

Aspect 51: The method of any of Aspects 43-50, further comprising transmitting the second signal configuration to the UE.

Aspect 52: The method of any of Aspects 43-51, wherein configuring the UE to apply the second signal configuration includes configuring the UE to convert one or more SBFD slots or one or more IBFD slots into additional UL slots.

Aspect 53: The method of Aspect 52, wherein configuring the UE to convert one or more SBFD slots or IBFD slots into additional UL slots includes configuring the UE to convert an entirety of each of the one or more SBFD slots or IBFD slots into the additional UL slot.

Aspect 54: The method of Aspect 52, wherein configuring the UE to convert one or more SBFD slots or IBFD slots into additional UL slots includes configuring the UE to convert one or more DL sub-bands into one or more UL sub-bands.

Aspect 55: An apparatus for wireless communication at a device, comprising a processor; memory coupled with the processor; and instructions stored in the memory and executable by the processor to cause the apparatus to perform the method of one or more of Aspects 1-54.

Aspect 56: A device for wireless communication, comprising a memory and one or more processors coupled to the memory, the one or more processors configured to perform the method of one or more of Aspects 1-54.

Aspect 57: An apparatus for wireless communication, comprising at least one means for performing the method of one or more of Aspects 1-54.

Aspect 58: A non-transitory computer-readable medium storing code for wireless communication, the code comprising instructions executable by a processor to perform the method of one or more of Aspects 1-54.

Aspect 59: A non-transitory computer-readable medium storing a set of instructions for wireless communication, the set of instructions comprising one or more instructions that, when executed by one or more processors of a device, cause the device to perform the method of one or more of Aspects 1-54.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) for wireless communication, comprising:
a memory; and
one or more processors, coupled to the memory, configured to:
receive a first signal configuration including one or more initial downlink (DL) slots or symbols and one or more initial uplink (UL) slots or symbols;
receive signaling indicating a transition of a network node to a low energy state; and
apply a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

2. The UE of claim 1, wherein the second signal configuration converts the one or more initial UL slots or symbols into the additional DL slots or symbols.

3. The UE of claim 2, wherein the first signal configuration includes a first control resource set (CORESET) configuration for the one or more initial DL slots or symbols, and wherein applying the second signal configuration includes applying the first CORESET configuration to the additional DL slots or symbols.

4. The UE of claim 2, wherein the first signal configuration includes a first control resource set (CORESET) configuration for the one or more initial DL slots or symbols, and wherein applying the second signal configuration includes applying a second CORESET configuration to the additional DL slots or symbols.

5. The UE of claim 2, wherein the first signal configuration includes a first bandwidth part (BWP) configuration for the one or more initial DL slots or symbols, and wherein applying the second signal configuration includes applying a second BWP configuration to the additional DL slots or symbols.

6. The UE of claim 2, wherein the first signal configuration further includes one or more flexible slots or symbols, and wherein applying the second signal configuration includes converting each of the one or more flexible slots or symbols into supplemental DL slots or symbols, wherein the additional DL slots or symbols include the supplemental DL slots or symbols.

7. The UE of claim 2, wherein the one or more processors are further configured to transition to a sleep state in response to receiving the signaling indicating the transition of the network node to the low energy state, wherein the sleep state occurs during the additional DL slots or symbols or during the one or more initial UL slots or symbols.

8. The UE of claim 2, wherein the one or more processors, to apply the second signal configuration, are configured to limit communication during the one or more initial UL slots or symbols to a communication type.

9. The UE of claim 2, wherein applying the second signal configuration includes converting one or more sub-band full duplex (SBFD) slots or one or more in-band full duplex (IBFD) slots into supplemental DL slots, wherein the additional DL slots or symbols include the supplemental DL slots.

10. The UE of claim 9, wherein the one or more processors, to convert the one or more SBFD slots or the one or more IBFD slots into the supplemental DL slots, are configured to convert an entirety of each of the one or more SBFD slots or the one or more IBFD slots into the supplemental DL slots.

11. The UE of claim 9, wherein the one or more processors, to convert the one or more SBFD slots or the one or more IBFD slots into the supplemental DL slots, are configured to convert one or more UL sub-bands of the one or more SBFD slots or the one or more IBFD slots into one or more DL sub-bands.

12. The UE of claim 1, wherein the second signal configuration converts the one or more initial DL slots or symbols into the additional UL slots or symbols.

13. The UE of claim 12, wherein the first signal configuration includes a first control resource set (CORESET) configuration for the one or more initial UL slots or symbols, and wherein applying the second signal configuration includes applying the first CORESET configuration to the additional UL slots or symbols.

14. The UE of claim 12, wherein the first signal configuration includes a first control resource set (CORESET) configuration for the one or more initial UL slots or symbols, and wherein applying the second signal configuration includes applying a second CORESET configuration to the additional UL slots or symbols.

15. The UE of claim 12, wherein the first signal configuration includes a first bandwidth part (BWP) configuration for the one or more initial UL slots or symbols, and wherein applying the second signal configuration includes applying a second BWP configuration to the additional UL slots or symbols.

16. The UE of claim 12, wherein the first signal configuration includes one or more flexible slots or symbols, and wherein applying the second signal configuration includes converting each of the one or more flexible slots or symbols into supplemental UL slots or symbols, wherein the additional UL slots or symbols include the supplemental UL slots or symbols.

17. The UE of claim 12, wherein the one or more processors are further configured to transition to a sleep state in response to the signaling indicating the transition of the network node to the low energy state, wherein the sleep state occurs during the additional UL slots or symbols or during the one or more initial DL slots or symbols.

18. The UE of claim 12, wherein applying the second signal configuration includes converting one or more sub-band full duplex (SBFD) slots or one or more in-band full duplex (IBFD) slots into supplemental UL slots, wherein the additional UL slots or symbols include the supplemental UL slots.

19. The UE of claim 18, wherein the one or more processors, to convert the one or more SBFD slots or the one or more IBFD slots into the supplemental UL slots, are configured to convert an entirety of each of the one or more SBFD slots or the one or more IBFD slots into the supplemental UL slots.

20. The UE of claim 18, wherein the one or more processors, to convert the one or more SBFD slots or the one or more IBFD slots into the supplemental UL slots, are configured to convert one or more DL sub-bands of the one or more SBFD slots or the one or more IBFD slots into one or more UL sub-bands.

21. The UE of claim 1, wherein the signaling indicating the transition of the network node to the low energy state includes the second signal configuration.

22. The UE of claim 1, wherein the one or more processors are further configured to receive, from a network entity, the second signal configuration. 23 A network node for wireless communication, comprising:
a memory; and
one or more processors, coupled to the memory, configured to:
transmit a first signal configuration including one or more initial downlink (DL) slots or symbols and one or more initial uplink (UL) slots or symbols;
transmit signaling indicating a transition of the network node to a low energy state; and
configure a user equipment (UE) to apply a second signal configuration based at least in part on the signaling indicating the transition of the network node to the low energy state,
wherein the second signal configuration converts the one or more initial UL slots or symbols into additional DL slots or symbols, or the second signal configuration converts the one or more initial DL slots or symbols into additional UL slots or symbols.

24. The network node of claim 23, wherein the second signal configuration converts the one or more initial UL slots or symbols into the additional DL slots or symbols, and wherein the first signal configuration further includes one or more flexible slots or symbols, and wherein applying the second signal configuration includes converting each of the one or more flexible slots or symbols into supplemental DL slots or symbols, wherein the additional DL slots or symbols include the supplemental DL slots or symbols.

25. The network node of claim 23, wherein the second signal configuration converts the one or more initial DL slots or symbols into the additional UL slots or symbols, and wherein the first signal configuration includes one or more flexible slots or symbols, and wherein applying the second signal configuration includes converting each of the one or more flexible slots or symbols into supplemental UL slots or symbols, wherein the additional UL slots or symbols include the supplemental UL slots or symbols.

26. A method of wireless communication performed by a user equipment (UE), comprising:
receiving a first signal configuration including one or more initial downlink (DL) slots or symbols and one or more initial uplink (UL) slots or symbols;
receiving signaling indicating a transition of a network node to a low energy state; and
applying a second signal configuration based at least in part on the signaling indicating the transition of the network node to the low energy state, wherein the second signal configuration converts the one or more initial UL slots or symbols into additional DL slots or symbols or the second signal configuration converts the one or more initial DL slots or symbols into additional UL slots or symbols.

27. A method of wireless communication performed by a network node, comprising:
transmitting a first signal configuration including one or more initial downlink (DL) slots or symbols and one or more initial uplink (UL) slots or symbols;
transmitting signaling indicating a transition of the network node to a low energy state; and
configuring a user equipment (UE) to apply a second signal configuration based at least in part on the signaling indicating the transition of the network node to the low energy state, wherein the second signal configuration converts the one or more initial UL slots or symbols into additional DL slots or symbols, or the second signal configuration converts the one or more initial DL slots or symbols into additional UL slots or symbols.
